(19) United States
(12) Patent Application Publication
(10) Pub. No.: US 2018/0300388 A1
(43) Pub. Date: Oct. 18, 2018

(54) SYSTEM AND METHOD FOR AUTOMATIC DATA ENRICHMENT FROM MULTIPLE PUBLIC DATASETS IN DATA INTEGRATION TOOLS

(71) Applicant: International Business Machines Corporation, Armonk, NY (US)

(72) Inventors: Manish A. Bhide, Hyderabad (IN); Jo A. Ramos, Grapevine, TX (US)

(21) Appl. No.: 15/488,748

(22) Filed: Apr. 17, 2017

(51) Int. Cl. G06F 17/30

(52) U.S. Cl. CPC G06F 17/30598; G06F 17/30498

(57) ABSTRACT

A source dataset is enriched by standardization of address data, date and time analysis, and demographic analysis. The enriched source dataset is used to form one or more distinct clusters that are unique combinations of values for one or more attributes of the enriched source dataset. One or more related datasets are found for each of the clusters, and the related datasets are merged into the enriched source dataset using a distributed join operation, wherein the distributed join allows each row of the source dataset to be joined with a different one of the related datasets, where the different one of the related datasets is closest to the cluster to which the row belongs.

### BACKGROUND

Data preparation in cloud-based computing is typically focused on the citizen analyst and business analyst personas. Data preparation tools in general are interactive, self-service and easy to use.

There has been some work in extracting data from external data sources for enriching datasets for use in data integration tools. However, data integration tools traditionally have been focused on the data engineer persona and hence are very difficult to use.

Thus, there is a need in the art for improvements for automatic data enrichment from, for example, public datasets for use in data integration tools. The present invention satisfies this need.

### SUMMARY

The invention provided herein has a number of embodiments useful, for example, in automatic data enrichment. A source dataset is enriched by standardization of address data, date and time analysis, and demographic analysis. The enriched source dataset is used to form one or more distinct clusters that are unique combinations of values for one or more attributes of the enriched source dataset. One or more related datasets are found for each of the clusters, and the related datasets are merged into the enriched source dataset using a distributed join operation, wherein the distributed join allows each row of the source dataset to be joined with a different one of the related datasets, where the different one of the related datasets is closest to the cluster to which the row belongs.

### BRIEF DESCRIPTION OF THE DRAWINGS

Referring now to the drawings in which like reference numbers represent corresponding parts throughout:

FIG. 1 depicts a cloud computing environment according to an embodiment of the present invention.

FIG. 2 depicts abstraction model layers according to an embodiment of the present invention.

FIG. 3 illustrates a distributed computing environment, according to one embodiment.

FIG. 4 is a flowchart illustrating the data analytics processing that is performed, according to one embodiment.

### DETAILED DESCRIPTION

In the following description, reference is made to the accompanying drawings which form a part hereof, and in which is shown by way of illustration one or more specific embodiments in which the invention may be practiced. It is to be understood that other embodiments may be utilized and structural and functional changes may be made without departing from the scope of the present invention.

Overview

This disclosure describes a cloud-based data refinery, which ingests data, refines it and makes it available across an enterprise. Specifically, the data refinery offers capabilities to load, identify, cleanse, refine and merge data as a cloud-based service.

This data refinery performs a computer-implemented method for automatically analyzing data to learn more information about the data, forming clusters of unique features from the data, and then using the clusters to find the closest additional data for enriching the data. In one embodiment, the data is automatically analyzed to identify addresses, dates and times, and demographics, in the data; clusters of unique features are formed from the data; and then the closest additional data is extracted from other sources using the clusters.

Cloud Computing

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

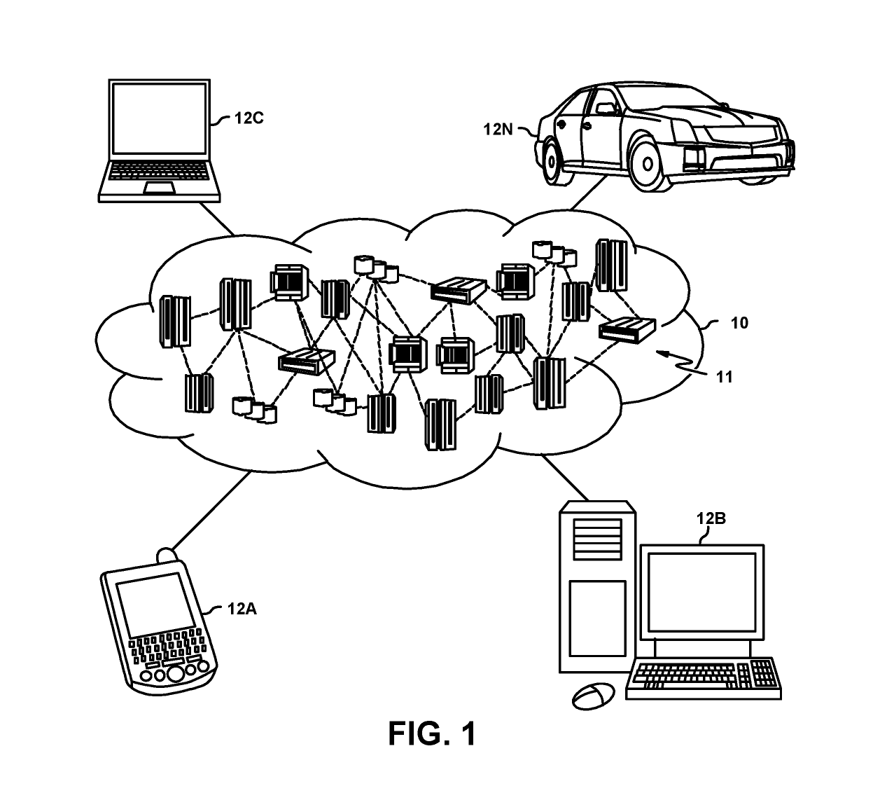

Referring now to FIG. 1, illustrative cloud computing environment 10 is depicted. As shown, cloud computing environment 10 includes one or more cloud computing nodes 11 with which local computing devices used by cloud consumers, such as, for example, personal digital assistant (PDA) or cellular telephone 12A, desktop computer 12B, laptop computer 12C, and/or automobile computer system 12N may communicate. Nodes 11 may communicate with one another. They may be grouped (not shown) physically or virtually, in one or more networks, such as Private, Community, Public, or Hybrid clouds as described hereinabove, or a combination thereof. This allows cloud computing environment 10 to offer infrastructure, platforms and/or software as services for which a cloud consumer does not need to maintain resources on a local computing device. It is understood that the types of computing devices 12A-N shown in FIG. 1 are intended to be illustrative only and that computing nodes 11 and cloud computing environment 10 can communicate with any type of computerized device over any type of network and/or network addressable connection (e.g., using a web browser).

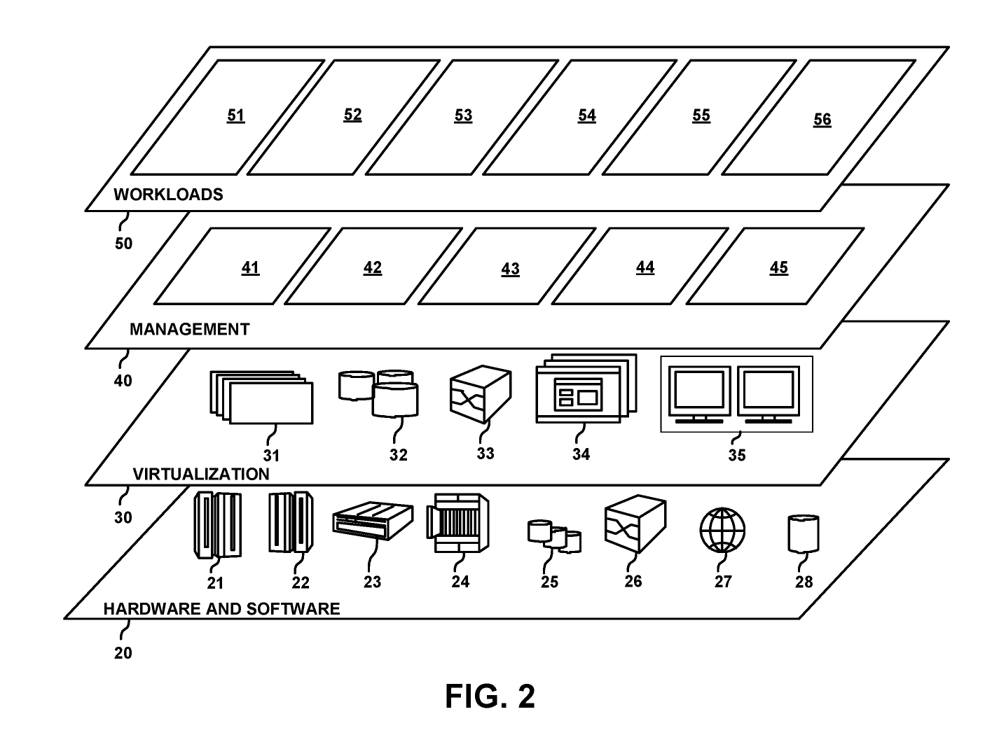

Referring now to FIG. 2, a set of functional abstraction layers provided by cloud computing environment 10 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 20 includes hardware and software components.

Examples of hardware components include: one or more computers such as mainframes 21, RISC (Reduced Instruction Set Computer) architecture based servers 22, servers 23, and blade servers 24; storage devices 25; and networks and networking components 26. In some embodiments, software components include network application server software 27 and database software 28.

Virtualization layer 30 provides an abstraction layer from which the following examples of virtual entities may be provided: virtual servers 31; virtual storage 32; virtual networks 33, including virtual private networks; virtual applications and operating systems 34; and virtual clients 35.

In one example, management layer 40 may provide the functions described below. Resource provisioning 41 provides dynamic procurement of computing resources and other resources that are utilized to perform tasks within the cloud computing environment 10. Metering and pricing 42 provide cost tracking as resources are utilized within the cloud computing environment 10, and billing or invoicing for consumption of these resources. In one example, these resources may include application software licenses. Security provides identity verification for cloud consumers and tasks, as well as protection for data and other resources. User portal 43 provides access to the cloud computing environment 10 for consumers and system administrators. Service level management 44, which includes containers, provides cloud computing resource allocation and management such that required service levels are met. Service Level Agreement (SLA) planning and fulfillment 45 provide pre-arrangement for, and procurement of, cloud computing resources for which a future requirement is anticipated in accordance with an SLA.

Workloads layer 50 provides examples of functionality for which the cloud computing environment 10 may be utilized. Examples of workloads, tasks and functions which may be provided from this layer include: data analytics processing 51; transaction processing 52; mapping and navigation 53; software development and lifecycle management 54; virtual classroom education delivery 55; etc.

Distributed Computing Environment

The cloud computing environment 10 of FIGS. 1 and 2 may be used to implement a distributed computing environment. One example of a distributed computing environment comprises the data analytics processing 51 of very large datasets stored across one or more nodes 11. This is referred to as “big data,” which is a term for datasets that are so large or complex that traditional data processing applications are inadequate to deal with them.

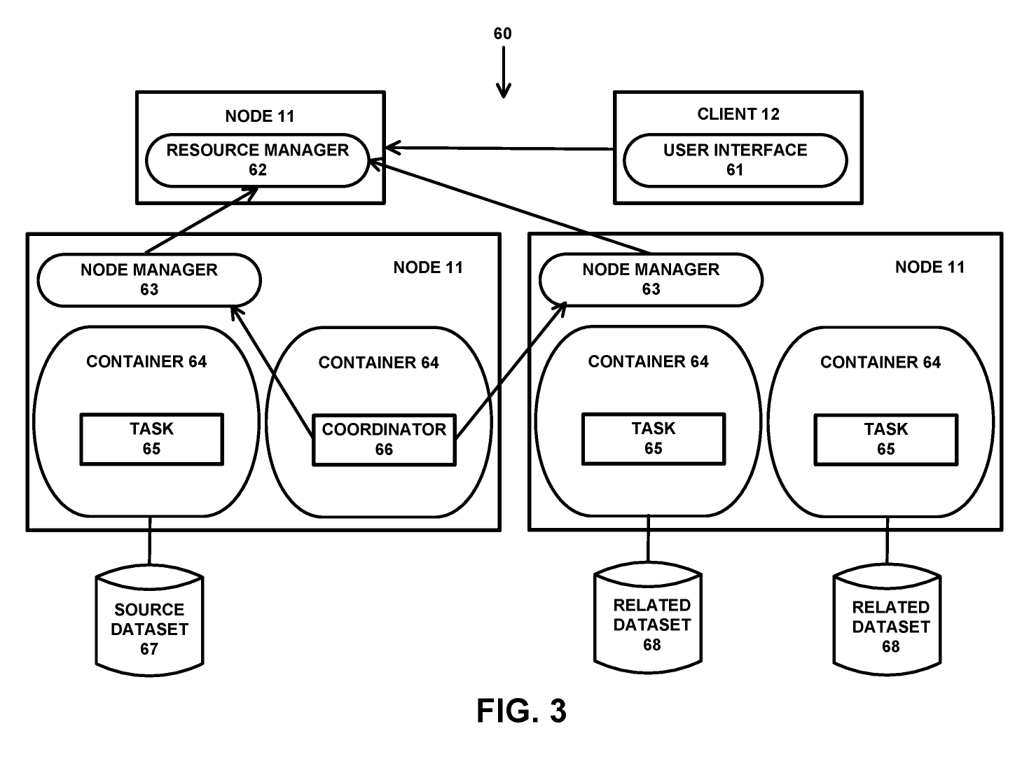

FIG. 3 illustrates a distributed computing environment 60 used for the data analytics processing 51, according to one embodiment. The distributed computing environment 60 is comprised of the following modules:
a user interface 61, which allows a user to control the data analytics processing 51;
a resource manager 62, which schedules and arbitrates all available resources;
a per-node node manager 63, which takes direction from the resource manager 62 and is responsible for managing resources available on a single node 11;
one or more containers 64, which provide an execution environment for executing one or more tasks 65 of the data analytics processing 51;
a coordinator 66, which is responsible for coordinating the execution of multiple tasks 65; and
a source dataset 67 and one or more related datasets 68.

The distributed computing environment 60 may store the datasets 67, 68 on a single node 11 or may distribute the datasets 67, 68 across the nodes 11 for accessing in parallel. Similarly, the distributed computing environment 60 may perform the tasks 65 on a single node 11 or may distribute the tasks 65 across the nodes 11 for execution in parallel. This parallelism approach may take advantage of data locality, with the nodes 11 manipulating the data they have access to, to allow the data to be processed faster and more efficiently than it would be in a more conventional computer architecture that relies on a parallel file system where computation and data are distributed via high-speed networking.

Processing

In one embodiment, the data analytics processing 51 performs a computer-implemented method for enriching a source dataset, using the enriched source dataset to form distinct clusters, finding related datasets for each of the clusters, and then merging the related datasets into the enriched source dataset using a distributed join operation. The goal is to radically simplify the data integration performed by the data analytics processing 51.

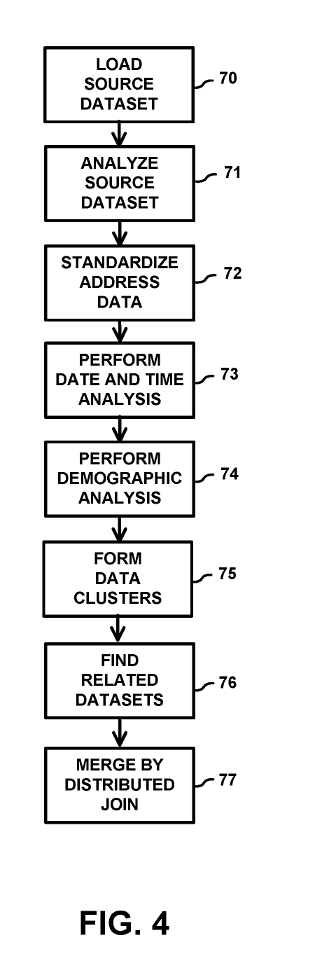

FIG. 4 is a flowchart illustrating the steps of the computer-implemented method, according to one embodiment.

Block 70 represents a source dataset 67 being loaded into one or more nodes 11 from one or more data storage devices 25.

Block 71 represents the tasks 65 analyzing the source dataset 67 to automatically identify and classify columns that contain various types of data. In order to perform this identification, the tasks 65 can make use of existing tools and methods.

Block 72 represents the tasks 65 enriching the source dataset 67 by standardizing address data therein. Such standardization of the address data may include parsing the address data into various fields, such as house number, street name, state and zip code.

Block 73 represents the tasks 65 enriching the source dataset 67 by date and time analysis. Such analysis of the date and time may include identifying a date, time or timestamp range for the source dataset 67.

In one embodiment, this step can be performed by identifying one or more columns of the source dataset 67 having a type of date, time or timestamp, or by parsing one or more string columns of the source dataset 67 to detect a string comprising a date, time or timestamp.

In one embodiment, this step may involve forming a date, time or timestamp range from one or more columns comprised of dates, times or timestamps. Consider, for example, where the source dataset 67 includes attributes of Sale_Date and Return_Date, and a row includes a Sale_Date of 1 Jun. 2015 and a Return_Date of 20 Jun. 2015. The tasks 65 may form a range of “1st to 20th June 2015.” The tasks 65 may also convert the range into “June-2015” (i.e., one level higher). If two dates are across months, but belong to the same quarter, the tasks 65 may identify the range as a quarter. If the dates are across quarters, then the tasks 65 may identify the range as a year. If the dates are across years, then the tasks 65 may identify the range with the later of the dates. Other types of date, time and timestamp processing may also be performed.

Block 74 represents the tasks 65 enriching the source dataset 67 by demographic analysis. Such analysis of the demographics may include automatically discovering names, genders, ethnicities, etc., of people found in the source dataset 67.

In one embodiment, the source dataset 67 may contain information about people (customers, vendors, etc.), and the tasks 65 automatically identify and classify one or more columns of the source dataset 67 containing that information as person names. Once identified and classified as person names, the tasks 65 may extract additional information for the person names, such as given name, surname, gender, ethnicity, etc., and add the additional information to the source dataset 67. This information can be extracted using technology such as the Global Name Recognition™ product.

Block 75 represents the tasks 65 using the enriched source dataset 67 to form one or more distinct clusters. Each of the clusters may comprise a unique combination of values for one or more attributes of the enriched source dataset 67, including the standardized address data, the date, time or timestamp range, person names, and the additional information for the person names, such as given name, surname, gender, ethnicity, etc.

In one embodiment, the tasks 65 form the clusters by aggregating distinct values for one or more combinations of one or more attributes of the enriched source dataset 67. This may include aggregating distinct values found in the source dataset 67 for the standardized address data, the date, time or timestamp range, person names, and the additional information for the person names, such as given name, surname, gender, ethnicity, etc.

Block 76 represents the tasks 65 finding one or more related datasets 68 from one or more external data sources for each of the clusters.

Various external data sources may be used, such as catalog.data.gov, or the external data sources may be selected from a catalog that contains references (metadata) to external data sources. The related datasets 68 may include information not found in the source dataset 67, such as average household income, average property prices, average property prices, average crime rate, population density, etc.

In one embodiment, the related datasets 68 are identified by preconfigured extraction. In preconfigured extraction, the tasks 65 statically identify the related datasets 68 using the attributes of the cluster independently or in combination. For example, when the related datasets 68 are from catalog.data.gov, the tasks 65 may find a related dataset 68 comprised of Hispanic household income data for Q1 2015 when the cluster includes attributes where the name is Hispanic and the date range is Q1 2015. Other examples may use other clusters, other attributes and other related datasets 68.

In one embodiment, the related data is extracted by user-governed extraction. In user-governed extraction, the tasks 65 display the different clusters in the user interface 61 for selection by the user. For example, the clusters may comprise Hispanic NY 2015, Asian NY 2014, etc. For each of the clusters, the tasks 65 may display the related datasets 68 that are the most relevant in the user interface 61 for selection by the user. In this way, the user will know which related datasets 68 will be used for each cluster.

In one embodiment, it may happen that the related dataset 68 might not contain any dates, times or timestamps. In such a scenario, the tasks 65 may select the related datasets 68 based on other attributes, and then identify other related datasets 68, for example, using a primary key-foreign key relationship with the selected related datasets 68. The tasks 65 may traverse a first nesting level, i.e., only consider those other related datasets 68 that directly join with the selected related datasets 68 to determine if dates, time or timestamps are present. If not found, the tasks 65 may repeatedly traverse to a next nesting level of the other related datasets 68, until one or more columns of dates, times or timestamps are found.

Once the related datasets 68 that are the most relevant to the clusters are found, Block 77 represents the tasks 65 merging one or more of the related datasets 68 into the enriched source dataset 67 using a distributed join operation. In this context, a distributed join allows each row in the enriched source dataset 67 to be joined with a different one of the related datasets 68, where the different one of the related datasets 68 is closest to the cluster to which the row belongs.

A distributed join operation makes it possible to combine the source dataset 67 with the related datasets 68 by combining one or more rows from the related datasets 68 with the row from the source dataset 67. The rows, or portions of rows, from the related datasets 68 are concatenated horizontally with the row from the source dataset 67. The cluster identifies the attributes or columns through which the rows can be combined by the distributed join operation.

For example, if Row 1 of the source dataset 67 belongs to Cluster 1 and the related dataset 68 that is most relevant to Cluster 1 is Related Dataset 1, then Row 1 of the source dataset 67 will be joined with Related Dataset 1 through one or more of the attributes of Cluster 1. Similarly, Row 2 of the source dataset 67 belongs to Cluster 2 and the related dataset 68 that is most relevant to Cluster 2 is Related Dataset 2, then Row 2 of the source dataset 67 will be joined with Related Dataset 2 through one or more of the attributes of Cluster 2.

In one embodiment, the tasks 65 may or may not concatenate the rows based on one, a subset or all of the attributes in the cluster. Specifically, the values of each attribute may be used independently or in combination. For example, Hispanic NY 2015 may be one cluster, where Hispanic is from the ethnicity, NY is from the standardized address data, and 2015 is from the time range, and one, a subset, or all of these attributes may be used to join rows from the related datasets 68 to the enriched source dataset 67.

In summary, this invention describes a system and method for: enriching a source dataset 67 by address standardization, date and time analysis, and demographic analysis; using the enriched source dataset 67 to form one or more distinct clusters; finding one or more related datasets 68 that are most relevant for each of the clusters; and merging one or more of the related datasets 68 into the enriched source dataset 67 using a distributed join operation. The distributed join allows each row of the source dataset 67 to be joined with a different one of the related datasets 68, where the different one of the related datasets 68 is closest to the cluster to which the row of the source dataset 67 belongs.

Computer Program Product

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart illustrations and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart illustrations and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart illustrations and/or block diagram block or blocks.

The flowchart illustrations and block diagrams in the Figures illustrate the architecture, functionality, and operation of possible implementations of systems, methods, and computer program products according to various embodiments of the present invention. In this regard, each block in the flowchart illustrations or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

### CONCLUSION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
enriching, in one or more computers, a source dataset;
using, in one or more computers, the enriched source dataset to form one or more clusters;
finding, in one or more computers, one or more related datasets for each of the clusters; and
merging, in one or more computers, one or more of the related datasets into the enriched source dataset using a distributed join operation.

2. The method of claim 1, wherein the source dataset is enriched by standardization of address data.

3. The method of claim 1, wherein the source dataset is enriched by date and time analysis.

4. The method of claim 1, wherein the source dataset is enriched by demographic analysis.

5. The method of claim 1, wherein the clusters are distinct clusters.

6. The method of claim 1, wherein the related datasets are selected by a user.

7. The method of claim 1, wherein the distributed join allows each row of the source dataset to be joined with a different one of the related datasets, where the different one of the related datasets is closest to the cluster to which the row belongs.

8. A system, comprising:
one or more computers programmed for:
enriching a source dataset;
using the enriched source dataset to form one or more clusters;
finding one or more related datasets for each of the clusters; and
merging one or more of the related datasets into the enriched source dataset using a distributed join operation.

9. The system of claim 8, wherein the source dataset is enriched by standardization of address data.

10. The system of claim 8, wherein the source dataset is enriched by date and time analysis.

11. The system of claim 8, wherein the source dataset is enriched by demographic analysis.

12. The system of claim 8, wherein the clusters are distinct clusters.

13. The system of claim 8, wherein the related datasets are selected by a user.

14. The system of claim 8, wherein the distributed join allows each row of the source dataset to be joined with a different one of the related datasets, where the different one of the related datasets is closest to the cluster to which the row belongs.

15. A computer program product, the computer program product comprising a computer readable storage medium having program instructions embodied therewith, the program instructions executable by one or more computers to cause the computers to perform a method comprising:
enriching a source dataset;
using the enriched source dataset to form one or more clusters;
finding one or more related datasets for each of the clusters; and
merging one or more of the related datasets into the enriched source dataset using a distributed join operation.

16. The computer program product of claim 15, wherein the source dataset is enriched by standardization of address data.

17. The computer program product of claim 15, wherein the source dataset is enriched by date and time analysis or demographic analysis.

18. The computer program product of claim 15, wherein the clusters are distinct clusters.

19. The computer program product of claim 15, wherein the related datasets are selected by a user.

20. The computer program product of claim 15, wherein the distributed join allows each row of the source dataset to be joined with a different one of the related datasets, where the different one of the related datasets is closest to the cluster to which the row belongs.
